(19) United States
(12) Patent Application Publication
(10) Pub. No.: US 2020/0035112 A1
(43) Pub. Date: Jan. 30, 2020

(54) PROFILED TUTORIAL FLAGGING IN AUGMENTED REALITY

(71) Applicant: International Business Machines Corporation, Armonk, NY (US)

(72) Inventors: Mark Delaney, Raleigh, NC (US); Zachary Silverstein, Austin, TX (US); Robert H. Grant, Atlanta, GA (US); Paul Bergen, Hillsborough, NJ (US)

(21) Appl. No.: 16/048,942

(22) Filed: Jul. 30, 2018

(51) Int. Cl. G09B 5/06; G06F 17/30; G06T 19/00

(52) U.S. Cl. CPC G09B 5/065; G06F 3/04817; G06T 19/006; G06F 17/3053

(57) ABSTRACT

A computer-implemented method includes determining a plurality of tutorials associated with a product visible through an augmented reality (AR) viewer in an AR system. The plurality of tutorials are filtered based on a user profile to generate a candidate set of tutorials. One or more flags are dynamically generated to represent one or more tutorials in the candidate set of tutorials.

### BACKGROUND

The present invention relates to augmented reality and, more specifically, to profiled tutorial flagging in augmented reality.

Augmented reality (AR) is an experience in which a real-world environment is augmented, or enhanced, by the inclusion of virtual objects that represent computer-generated perceptual information. For example, AR can be experienced through glasses or contact lenses worn by a user, or by viewing the real world through a device, such as the screen of a smartphone that displays the real world through the use of a camera, along with virtual objects shown together with the real world. Generally, when using AR, a user sees the real world as well as additional information generated by a computer.

AR can assist people in learning how to use products. AR tutorials exist to enable a user to learn how to use a product while viewing or interacting with the product. For example, through an AR viewer, such as a smartphone display or AR glasses, a user sitting in the driver's seat of a vehicle may see the real-world vehicle controls along with virtual indications of available tutorials. For instance, near a real-world steering wheel, the AR viewer may show a circle that indicates there is a steering tutorial available. If the user reaches out and touches a location in the real world corresponding to the virtual location of the circle, then the steering tutorial may be initiated.

### SUMMARY

Embodiments of the present invention are directed to a computer-implemented method for flagging tutorials in an augmented reality system. A non-limiting example of the computer-implemented method includes determining a plurality of tutorials associated with a product visible through an augmented reality (AR) viewer in an AR system. The plurality of tutorials are filtered based on a user profile to generate a candidate set of tutorials. One or more flags are dynamically generated to represent one or more tutorials in the candidate set of tutorials.

Embodiments of the present invention are directed to a system for flagging tutorials in an augmented reality system. A non-limiting example of the system includes a memory having computer-readable instructions and one or more processors for executing the computer-readable instructions. The computer-readable instructions include determining a plurality of tutorials associated with a product visible through an AR viewer in an AR system. Further according to the computer-readable instructions, the plurality of tutorials are filtered based on a user profile to generate a candidate set of tutorials. One or more flags are dynamically generated to represent one or more tutorials in the candidate set of tutorials.

Embodiments of the invention are directed to a computer-program product for flagging tutorials in an augmented reality system, the computer-program product including a computer-readable storage medium having program instructions embodied therewith. The program instructions are executable by a processor to cause the processor to perform a method. A non-limiting example of the method includes determining a plurality of tutorials associated with a product visible through an AR viewer in an AR system. Further according to the method, the plurality of tutorials are filtered based on a user profile to generate a candidate set of tutorials. One or more flags are dynamically generated to represent one or more tutorials in the candidate set of tutorials.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a diagram of an augmented reality system according to some embodiments of the invention;

FIG. 2 is a flow diagram of a method of flagging tutorials in the AR system, according to some embodiments of the invention;

FIG. 3 is a display of an AR viewer in an example use, according to some embodiments of the invention; and

FIG. 4 is a block diagram of a computer system for implementing some or all aspects of the AR system, according to some embodiments of this invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two- or three-digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, conventionally, AR tutorials are created by developers and static to a product. In other words, there is an unchanging, fixed set of tutorials available to a user, where each tutorial is associated with a flag at a position associated with a physical aspect of the product. When the flag's position is in the field of view of the AR viewer, then the flag will be displayed. This current method is not dynamic. Specifically, for instance, conventionally, there is no way to add newly released tutorials or to filter the tutorials based on relevance to a user or to peers of the user.

Turning now to an overview of the aspects of the invention, one or more embodiments of the invention address the above-described shortcomings of the prior art by providing a mechanism to present to a user a subset of available tutorials, where the subset is selected based on the user's profile, which represents the user, and further based on profiles of similar users. The subset of tutorials may be dynamic, changeable due to the receipt of new tutorials or based on the user profile of the user. Further, the appearance (e.g., the look and feel) of a flag indicating a tutorial may be dynamic and may be based on the user's profile. A such, according to some embodiments of the invention, the tutorials presented to a user are selected to enhance that particular user's experience. A cognitive evaluation of the user, based on the user profile, leads to a determination of which tutorials to present and how those tutorials are presented.

The above-described aspects of the invention address the shortcomings of the prior art by providing an improved AR experience that is dynamic and customizable, based on a user, with respect to which tutorials are presented. As such, an AR viewer may be used to view tutorials selected to enhance a user's experience without bogging the user down in unnecessary information.

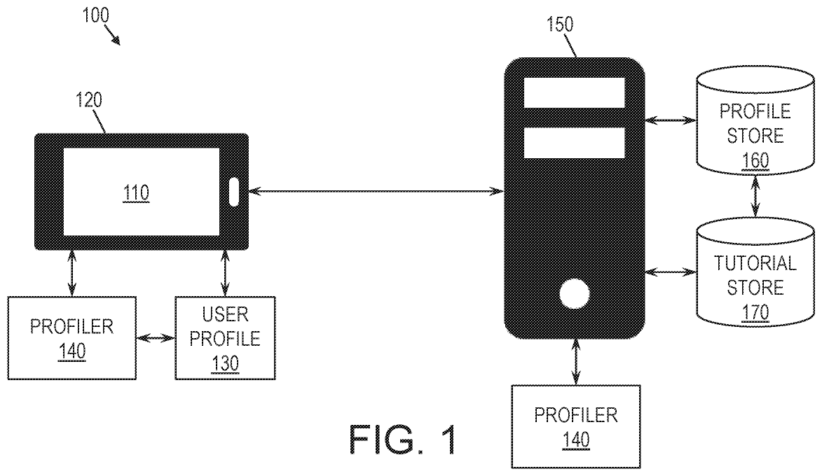

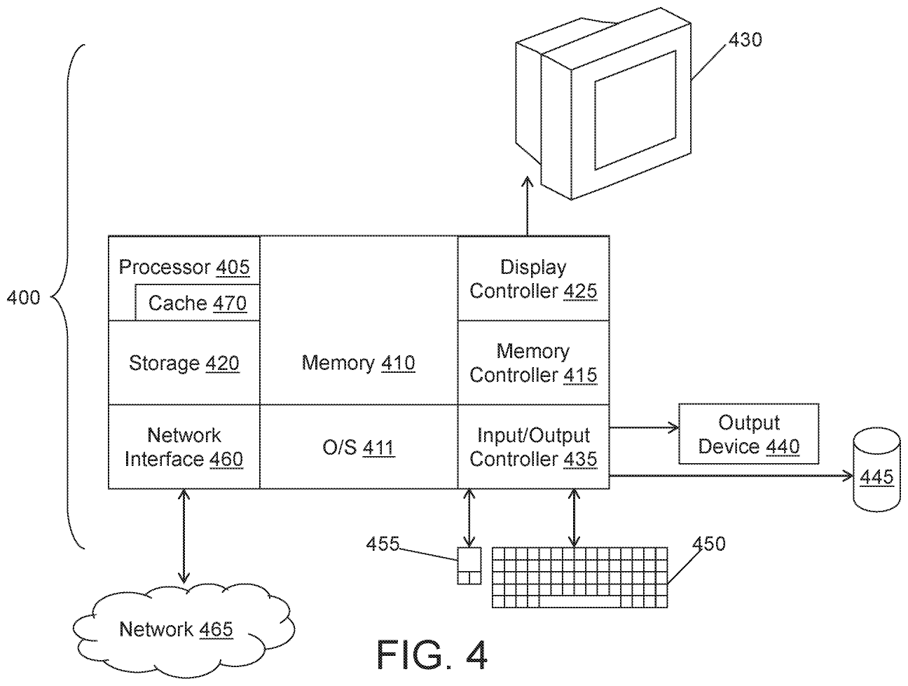

Turning now to a more detailed description of aspects of the present invention, FIG. 1 is a diagram of an augmented reality system 100 according to some embodiments of the invention. As shown in FIG. 1, the AR system 100 may include an AR viewer 110, as well as a computing device 120 for determining which tutorials to present to a user. For example, and not by way of limitation, the computing device 120 may be a computer system 400 as shown in FIG. 4. Although in FIG. 1, the AR viewer 110 is shown as a smartphone display, it will be understood that this need not be the case. Various devices may be used as the AR viewer 110, which may display virtual objects in combination with the real-world environment. For example, and not by way of limitation, the AR viewer 110 may alternatively be a pair of glasses capable of displaying virtual objects overlaid on the real world, which is visible through the lenses of the glasses.

The computing device 120 may be in communication with the AR viewer 110 and may perform some or all operations described herein to determine which tutorials are presented to a user, to determine how those tutorials are presented, and to instruct the AR viewer 110 to present indications of those tutorials. To this end, the computing device 120 may locally store or may have access to at least one user profile 130 associated with a corresponding user, where the user profile 130 may be used by the computing device 120 to select tutorials to be presented to the user. Further, in some embodiments of the invention, the computing device 120 may include a profiler 140, which may determine which tutorials to present to a user based on the user's associated user profile 130. The profiler 140 may include hardware, software, or a combination of both. For instance, the profiler 140 may be a software module or a special-purpose hardware circuit.

The computing device 120 may be integrated with the AR viewer 110, as in the case where the computing device 120 is a smartphone and the AR viewer 110 is a screen of the smartphone, or as in the case where the AR viewer 110 is a pair of glasses, and the computing device 120 is built into a frame of the glasses themselves. Alternatively, however, the computing device 120 may be a separate device in communication with the AR viewer 110, as in the case of a smartphone acting as the computing device 120 and being separate from an AR viewer 110, such as a pair of glasses.

In some embodiments of the invention, a remote server 150 may be in communication with the computing device 120 and may thus be, directly or indirectly, in communication with the AR viewer 110. The remote server 150 may include a profile store 160 and a tutorial store 170, each of which may be one or more databases, files, or storage devices capable of maintaining organized or searchable data. The remote server 150 may further include a profiler 140, which may determine which tutorials to present to a user based on the user's associated user profile. It will be understood that, although a profiler 140 is shown at both the local computing device 120 and the remote server 150 in FIG. 1, this is for illustrative purposes only, and a profiler 140 need not be present at both locations. In some embodiments of the invention, each of the profiler 140, the profile store 160, and the tutorial store 170 may reside locally at the computing device 120 rather than at the remote server 150.

The profile store 160 may include one or more user profiles 130, each associated with a respective user. Each user profile 130 may be embodied in one or more files, table entries, or tables, or one or more portions of such, and each user profile may describe the corresponding user. A user profile 130 may include various information about a user and may include references to accounts of the user on other platforms (e.g., social media, music applications), which may also be considered a part of the user profile 130. For example, and not by way of limitation, a user profile 130 may include information about the user's interests, skills, tutorials previously viewed, and products owned, which may be entered explicitly by the user himself or other users or may be inferred based on the user's activities (e.g., use of the AR system 100, social media posts and comments), for example.

A user utilizing the computing device 120 may indicate his identity, such as through authentication, which may be communicated to the remote server 150. The remote server 150 may then transmit the user profile 130 of the user to the computing device 120. If the user profile 130 is updated at the computing device 120, then the update may be transmitted to the remote server 150 for updating of the user profile 130 on the remote server 150 as well. In this manner, the user can use multiple computing devices 120 with the same user profile 130, as each such computing device 120 may communicate with the remote server 150 to receive the user profile 130.

The tutorial store 170 may include a plurality of tutorials, where each tutorial is associated with a respective product. When a tutorial is associated with a product, that tutorial may teach a lesson related to the product. In some embodiments of the invention, a tutorial may be interactive, expecting input from a user through the AR system 100. However, a tutorial may alternatively be capable of running to completion without interactions. The plurality of tutorials may include sets of tutorials, with each set being one or more tutorials associated with the same product. In other words, each known product may be associated with a corresponding set of tutorials about that product. Upon selection of a product, as will be described below, the tutorials associated with the product may be filtered based, at least in part, on a current user profile to result in all or a subset of those tutorials being presented to the user. This filtering may be performed by the profiler 140 and may occur at the remote server 150 or locally at the computing device 120.

In some embodiments of the invention, the tutorial store 170 is updatable through communications with one or more third-party servers. For example, a first product may be associated with a third-party server. This association may exist, for example, is a third party that operates the third-party server is a manufacturer or technical-support servicer of the product. Occasionally, a new tutorial for the first product may be added to the third-party server, and the third-party server may communicate the new tutorial to the remote server 150, or other device (e.g., the computing device 120 in communication with the AR viewer 110) on which the tutorial store 170 resides. The tutorial store 170 may then be updated by the remote server 150, or other device on which the tutorial store 170 resides, to include the new tutorial. Thus, because the tutorial store 170 is non-static, the AR system 100 may remain dynamic as well, to include new and updated tutorials as they become available.

It will be understood that the remote server 150 need not be included in the AR system 100. Rather, in some embodiments of the invention, storage and operations that could be performed remotely at the remote server 150 may instead take place locally at the computing device 120 or the AR viewer 110. In that case, transferring a user profile 130 between various computing devices 120 may be done, for example, by way of direct communication between computing devices 120. Further, in that case, the tutorial store 170 may reside locally at the computing device 120 and selection of tutorials to present to the user may also occur locally.

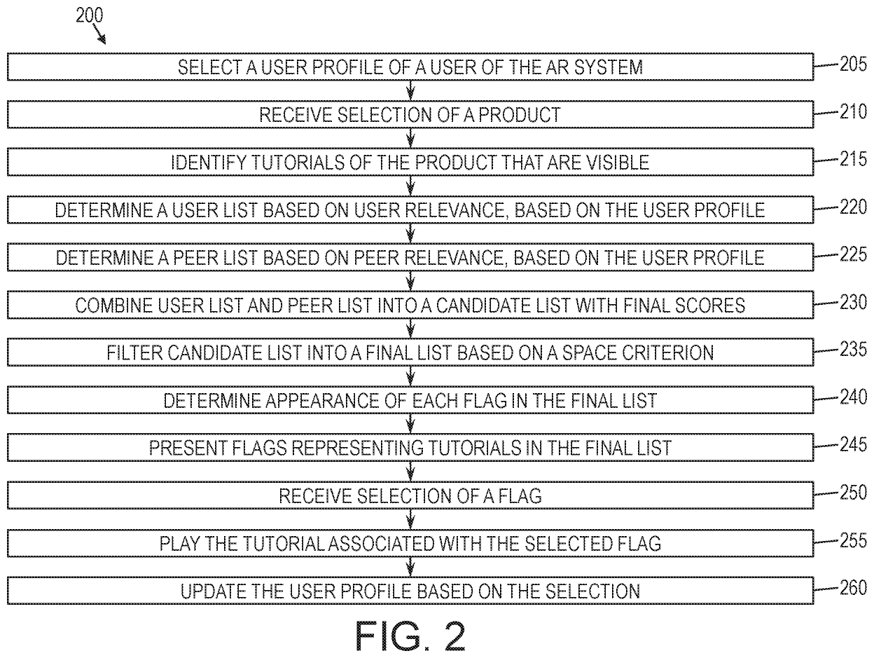

FIG. 2 is a flow diagram of a method 200 of flagging tutorials in the AR system, according to some embodiments of the invention. At block 205, the AR system 100 may select a user profile 130 of a user currently using the AR system 100. This may be done in various ways. For example, when the AR system 100 becomes active (e.g., after being turned on by a user), the AR system 100 may prompt the user to authenticate himself to the AR system 100 or to otherwise indicate his identity. Upon receiving the user's identity, through authentication or otherwise, the AR system 100 may locate a matching user profile 130 in the profile store 160, where a matching user profile 130 is a user profile 130 indicating an identity deemed the same as the identity indicated by the current user. The AR system 100 may then load the user profile 130, thus making the user profile 130 the current user profile 130 under consideration when selecting tutorials to present to the user.

At block 210, the AR system 100 may receive a selection of a product for which tutorials are to be presented. This may occur in various ways. For example, and not by way of limitation, the user may select a product from among a list of available products known to the AR system 100, the user may search for the product and then select the product in the AR system 100, or the product may be automatically identified based on the user's use of the AR viewer 110. For instance, when the AR viewer 110 is directed such that its field of view encompasses all or part of the product, the AR system 100 may detect the product through the AR viewer 110, based on seeing an identifier (e.g., a model number, a serial number) or other characteristic feature of the product.

At block 215, the AR system 100 may identify a set of tutorials for the product that are visible within the field of view of the AR viewer 110. Each tutorial associated with the product in the tutorial store 170 may be further associated with a region of the product. For example, and not by way of limitation, if the product is a car, a tutorial about steering may be associated with a region the outline of which tightly encloses the steering wheel of the product. Through image analysis techniques known in the art, the AR system 100 may be capable of detecting physical objects within the field of view. Thus, the AR system 100 may determine which regions associated with tutorials overlap, in whole or in part, the field of view. In some embodiments of the invention, it may be required that the entire region associated with a tutorial be within the field of view for the tutorial to be considered visible. Alternatively, however, only a portion of the region associated with a tutorial need be within the field of view for the corresponding tutorial to be deemed visible.

At blocks 220-225, as will be described below, the AR system 100 may analyze the user profile 130 to filter the visible tutorials. In some embodiments of the invention, the operations of these blocks may be performed by the profiler 140, which may reside at the computing device 120 or at the remote server 150. Further, while blocks 220-225 are shown as distinct, it will be understood that the activities of these blocks may be switched, or the activities of these blocks may be performed together rather than separately as shown in FIG. 2.

At block 220, the AR system 100 may determine a user list of tutorials based on user relevance, or user relevance scores, which may be determined from the user profile 130. The tutorials in the user list may be selected from the tutorials deemed visible. For example, user relevance may include considerations of the user's known interests, social media follows, owned or liked products, and skills, as indicated by the current user profile 130. For example, interests may have been explicitly indicated by the user and stored in the user profile 130 or may be determined based on social media, or based on the user's past interactions with the AR system 100. Social media follows refers to entities followed by the user on various social media platforms and thus may be incorporated into the user profile 130 through linking the AR system 100 with one or more social media platforms. Indications of products that are owned or liked by the user may be stored in the user profile 130. These may be known based on, for example, prior explicit indications by the user or based on prior tutorials viewed by the user. For instance, if the user previously used the AR system 100 to view a tutorial for a first product, then the user profile 130 of the user may include an indication of ownership or usership of the first product. Skills may be included in the user profile 130 based on, for example, explicit indications by the user or based on the user's social media interactions. Further, in some embodiments of the invention, other users connected with the user on the AR system 100 may be allowed to indicate information about the user, such as interests, products, or skills, which may be incorporated into the user's user profile 130, with or without confirmation by the user.

Each visible tutorial associated with the product may be assigned a user relevance score, representing the relevance of that tutorial to this specific user. The user relevance score may be an indication of the user's potential interest in the tutorial. It will be understood that various mechanisms may be used to determine user relevance. For example, and not by way of limitation, each tutorial may be associated with a set of keywords, which may include, for example, words describing topics of the tutorial. Each time a keyword occurs on the user profile 130 (e.g., including social media and other platforms linked to the user profile 130, including keywords associated with products the user has or has shown interest in, including keywords associated with tutorials the user has already viewed), the user relevance score for the tutorial may be incremented. For another example, each user profile 130 may be associated with keywords, which may be common words in the user profile 130 or words deemed important in the user profile 130. Each match between a keyword in a tutorial and a keyword of a user profile 130 may lead to incrementing the user relevance score for the tutorial. In some embodiments of the invention, after a user relevance score is determined for each visible tutorial available for the product, those user relevance scores may be normalized to set them within a desired range (e.g., between 0 and 1 inclusively).

A threshold user relevance may be set, for example, to a default value or to a value selected by the user. If the user relevance score for a tutorial meets (e.g., equals or exceeds) the threshold user relevance, then the tutorial may be included in a user list of tutorials.

In some embodiments of the invention, the user list may be screened, or filtered, to exclude tutorials deemed to lack utility due to the user's skills. In other words, a tutorial may be filtered out for being too basic or too advanced for the user. This may be performed by various mechanisms. For example, and not by way of limitation, each tutorial may belong to one or more classes, based on the tutorial topic, and may be associated with a skill score. Each class may be represented by a classifier, or class name. The available classes may be dependent on the product to which the tutorial relates. For example, and not by way of limitation, available classes for a product that is a vehicle may include the following: steering, automation, warning lights, music, and seating. The user may have a skill score associated with each class. For example, a high skill score may indicate high skill, while a low skill score may indicate low skill. The skill score may start at a default value and may be modified each time the user displays an indication of skill level. For instance, a skill score may be increased when skill associated with the respective class is displayed, and the skill score may be decreased when a lack of skill is displayed. For instance, the user or users connected to the user (e.g., via social media or via the AR system 100) may manually adjust the skill level for some or all classes. Further, when the user plays a tutorial, the user's skill level associated with the class of that tutorial may be adjusted to indicate an increase in skill. If the user's skill score in a particular class exceeds the skill score associated with a tutorial in that class, then the tutorial may be filtered out as being unnecessary, or too basic, for the user. In some embodiments of the invention, to avoid potential over-filtering, the user's skill score may be required to exceed the tutorial skill score by a threshold amount before the tutorial is filtered out.

Further, in some embodiments of the invention, some classes may be used in various products. For instance, a receiver, a car, and a home automation system may all be capable of playing music and may all have a music class of tutorials. As such, the user's skill score associated with a class may be the same across all products or across related products (e.g., all vehicles, all musical instruments). Thus, for each product that is new to the user, the user need not start at a default skill level for every tutorial.

The resulting user list of tutorials may be the set of visible tutorials for the product with highest user relevance scores and that are not filtered out due to skill scores.

At block 225, the AR system 100 may select a peer list of tutorials based on relevance to the user's peers. The tutorials in the peer list may be selected from the tutorials for the product deemed visible. In general, the peer list may be used because, in some cases, a user's demonstrated interests may not reflect what the user needs to learn about a product. Thus, peer relevance can ensure that the user sees tutorials that are relevant to others as well. With respect to the peer list, the term “peer” may refer to others utilizing the AR system 100. In some embodiments of the invention, the peers may be only those deemed similar to the user, but alternatively, no level of similarity need be determined or considered.

Each tutorial may be assigned a peer relevance score. This may be performed by various mechanisms. For example, and not by way of limitation, the peer relevance score of a tutorial may be based on how many peers have watched the tutorial, how peers have ranked the tutorial, or a combination of both. For instance, each tutorial may have a ranking, or review score, which may be an average of the rankings assigned by various peers. In some embodiments of the invention, a tutorial may have a total rank as well as a peer rank, where the peer rank is respective to a user and represents a ranking determined based on other users deemed to be peers, if not all other users are being considered peers. It will be understood that references to a tutorial's rank below may refer to either the peer rank or the total rank. In some embodiments of the invention, for example, to calculate the peer relevance score, the number of peers having watched the tutorial may be normalized to fall within a set range, the tutorial rank may be normalized to fall within the same range, and the peer relevance score may be the average or a weighted average of these two normalized values. For instance, the maximum number of peer watches received by a tutorial may be used as a denominator to normalize the number of peer watches of a first tutorial between 0 and 1, and the maximum possible rank may be used as a denominator to normalize a tutorial's rank between 0 and 1. These two values may then be combined into a peer relevance score for the tutorial. However, it will be understood that many other mechanisms can be used to determine the peer relevance score of a tutorial.

As mentioned above, in some embodiments of the invention, only other users deemed similar to the user need be considered peers. In this case, a function to measure user similarity may be used. Various mechanisms for measuring the similarity between users are known in the art and may be used according to some embodiments of the invention. For example, and not by way of limitation, keywords of the current user profile may be compared to keywords of a second user profile 130 of another user. For instance, a word in a user profile 130 may be deemed a keyword due to frequency or other indications of importance. A default similarity score between users may be 0. For each keyword in the second user profile 130 that matches a keyword in the current user profile 130, a similarity score between the other user and the current user may be incremented. For another example, for each product in common between the other user and the current user, and for each common interest or other commonality, the similarity score may be incremented. In some embodiments of the invention, each similarity score may be normalized to fix the similarity scores in a desired range, such as between 0 and 1. Another user may be deemed similar to the current user if the similarity score between the two meets a threshold similarity. Users deemed similar to the current user may be used as peers when determining peer relevance, and in some embodiments of the invention, non-peers need not be considered for determining peer relevance of a tutorial.

A threshold peer relevance may be set, for example, to a default value or to a value selected by the user. If the peer relevance score for a tutorial meets (e.g., equals or exceeds) the threshold peer relevance, then the tutorial may be included in the peer list of tutorials. In some embodiments of the invention, the peer list may be screened, or filtered, to exclude tutorials deemed to lack utility due to the user's skills, as described above with respect to the user list of tutorials. In other words, a tutorial may be filtered out for being too basic for the user. The resulting peer list of tutorials may be the set of visible tutorials for the product with highest peer relevance scores and that are not filtered out due to skill scores.

In some embodiments of the invention, a skill peer relevance score may be calculated for each tutorial. Generally, the skill peer relevance score of a tutorial may describe the relevance of the tutorial to the user based on a set of skill peers, which may be other users deemed to have similar skills to the user. The set of skill peers of a user may be same or may differ from the peers described above. Determining skill peer relevance scores for the various tutorials may involve identifying skill peers. For each tutorial, the skill peer relevance score may be incorporated into the peer relevance score of the tutorial, may be a distinct factor from the peer relevance score, or may be used as the peer relevance score itself, such that the peers selected for calculation of the various peer relevance scores are skill peers.

For example, and not by way of limitation, to identify skill peers, a least squares method may be applied to the user's set of skill scores as compared to another user's set of skill scores. Specifically, for each tutorial class, the user's respective skill score may be compared to the other user's respective skill score, and the differences between paired skill scores may be squared and summed. Other users deemed to be most like the user in terms of skills (e.g., having the lowest least squares values, or having least squares values below a threshold) may be deemed skill peers to the user. After determining such skill peers, the AR system 100 may determine a skill peer relevance score of each visible tutorial by, for instance, using the same methodology used to calculate peer relevance scores described above, except using only skill peers.

In some embodiments of the invention, for each tutorial that is visible, skill peer relevance may be a factor in calculating peer relevance. Alternatively, however, a skill peer list distinct from the peer list may be generated of tutorials having the highest skill peer relevance, or the skill peer list may be used as the peer list itself.

At block 230, tutorials in the user list and the peer list may be combined into a full candidate list of tutorials, with each tutorial on the candidate list being associated with a final score. At least initially, the candidate list may include all tutorials on the user list as well as all tutorials on the peer list. Determining the final scores may be done in various ways and may be based on the level of importance given to each list. As discussed above, tutorials in the user list may each have at least a user relevance score, and tutorials in the peer list may each have at least a peer relevance score. Some or all of the tutorials on the two lists may have both a user relevance score and a peer relevance score. Each tutorial on either list missing a user relevance score may be assigned a user relevance score of 0, and each tutorial on either list missing a peer relevance score may be assigned a peer relevance score of 0. In some embodiments of the invention, if the set of user relevance scores and the set of peer relevance scores do not fall within the same range, the peer relevance scores may be normalized within a fixed range (e.g., 0 to 1), and the user relevance scores may be normalized within the same range. The final score of each tutorial may be a sum or an average, such as a weighted sum or weighted average, of the user relevance score and the peer relevance score. If a weighted sum or weighted average is used, then the weights may be selected based on whether user interests or peer interests are deemed more important. Thus, each of the various tutorials in the candidate list may be assigned a final score. The tutorials may therefore be ranked according to their scores, resulting in the candidate list being a ranked list, or an ordered list.

In some embodiments of the invention, if a skill peer list is separate from the peer list, the skill peer list may be combined with the user list and the peer list to generate the candidate list. One of skill in the art will understand how to extend the above to include consideration of this third list into generation of the candidate list.

At block 235, the candidate list of tutorials may be filtered for fit considerations based on at least one fit criterion, or space criterion. When using augmented reality, the user's field of view is limited, at least by real-life limitations, such as eye position, but potentially also by physical limitations of the AR viewer 110, such as camera lens characteristics. When using the AR viewer 110, the user may be able to see objects, both physical and virtual, within the field of view while objects outside the field of view may not be visible. Eventually, each tutorial selected for presentation to the user may be associated with a flag, which may be displayed to the user through the AR viewer 110. Thus, the AR system 100 may determine a final list of tutorials by filtering the candidate list to enable each tutorial in the final list to have a flag that is visible and fits comfortably within the field of view.

Filtering the candidate list may be performed in various ways. There are heuristics known in the art for arranging objects within a fixed space, and such heuristics may be used for this purpose.

For example, and not by way of limitation, each tutorial may be selected from the candidate list and added to the final list based on rank, one at a time, if it is determined that the tutorial meets the required space criterion. Specifically, for instance, the space criterion may be that a flag of a tutorial be placeable within the associated region of the tutorial without overlapping a previously placed flag. Before adding a tutorial to the final list, a flag for the tutorial may be initially assigned to a position (e.g., the center) within the region associated with the tutorial. Although the positions assigned may be in a two-dimensional coordinate space of the AR viewer 110, it will be understood that this two-dimensional space overlays the three-dimensional space of the real world when the AR system 100 is active. A small area (e.g., a 20-pixel radius) around the flag position may be temporarily reserved for an icon associated with the flag. In some embodiments of the invention, there may exist preestablished flag sizes, and the small area may match or correspond to a smallest flag size available. The tutorial with the next highest rank in the candidate list may then be selected and an attempt may be made to position a flag for that tutorial in the field of view. If placing a flag at a designated position (e.g., the center) of the region associated with the tutorial would overlap a previously place flag, when considering the small area reserved around each flag, then the flag may be shifted away from the center as needed to avoid overlapping the reserved area around the existing flag. Further, an existing flag may be shifted, staying within the region associated with its tutorial. In this manner, the AR system 100 may attempt to determine a position for each tutorial in the candidate list, and when a position is identified, the tutorial may be added to the final list and associated with the current position of the corresponding flag. If a tutorial cannot be placed in the field of view, then that tutorial does not comply with the required space criterion and may thus be excluded from the from the final list.

For another example, a minimum count (e.g., 5 or 10) of tutorials may be selected, and it may be assumed that this small number of tutorials may be arranged to fit within the field of view. Specifically, the tutorials selected may be those that are highest ranked. In this case, the required space criterion may be that a tutorial is among the top-ranked tutorials in the candidate list, such that the tutorial is selected within the minimum count. Positions for these tutorials may be selected within the field of view, such that the position for each tutorial is within the region associated with the tutorial. In some embodiments of the invention, after those top-ranked tutorials are positioned and thus included in the final list, each tutorial in the candidate list may be handled in turn, starting from the highest ranked tutorial remaining and not yet on the final list. The AR system 100 may attempt to position each tutorial within the region associated with the tutorial, and those that cannot be placed may be excluded from the final list.

Thus, the AR system 100 may select tutorials from the candidate list for inclusion in the final list, and the AR system 100 may determine a position in the field of view for each tutorial on the final list.

At block 240, a flag appearance is determined for each tutorial in the final list. The appearance of a flag representing a tutorial may include both an icon and a size. As mentioned above, each tutorial in the final list may be associated with a flag position, which may be the position of a tutorial. Each flag may also be associated with an icon, which may be an image or graphic used to represent the flag. In other words, when the user looks into the AR viewer 110, the user may see the various flags associated with the tutorials in the final list, and each flag may have the appearance of the associated icon.

Selecting an icon for a tutorial may be performed by various mechanisms. For example, and not by way of limitation, there may be a default icon that may be used for all tutorials, or for each tutorial for which an alternative icon is not selected. For another example, there may be a default icon associated with a class of tutorials, and each tutorial in the final list may be assigned the icon associated with its class. For another example, the AR system 100 may mine the user profile 130 to identify an appropriate icon for a tutorial or for a class of tutorials in the final list. For instance, if it is determined from the user profile 130 that the user has most recently listened to a particular music album, then the cover of that album may be used as the icon to represent tutorials in a class related to music. For another example, if it is determined that the user has shown recent interest in a particular car, then an image of the car may be used as the icon for tutorials in a class related to steering or actual driving functionality of a vehicle. More generally, the associated user profile 130 may be mined, or analyzed, to identify an appropriate icon for each tutorial in the final list.

The size of each flag may also be determined. As mentioned above, there may be a preestablished set of available flag sizes (e.g., small, medium, and large), but this need not be the case. In some embodiments of the invention, one flag size may be selected for each class of tutorials, such that all tutorials of that class in the final list have flags of the same size. Flag sizes may be determined based on user relevance scores, peer relevance scores, or final scores, for example. As these scores are based, at least in part, on the user profile 130 of the user, the flag sizes may thus also be based on the user profile 130. For instance, each flag size may be associated with a score range, such that the final score of a tutorial maps to the flag size to be selected for the tutorial. Alternatively, for tutorials that were on the user list, the user relevance score may map to the flag size, and for tutorials that were on the peer list, the peer relevance score may map to the flag size. If a tutorial was on both the user list and the peer list, then the larger flag size mapped to by the user relevance score and peer relevance score may be used. After initial flag sizes are chosen, one or more flag sizes may be reduced if it is determined that flags would overlap due to their selected sizes.

At block 245, the various flags representing the tutorials in the final list may be presented to the user. Specifically, the flags may be generated and display through the AR viewer 110. Each flag may be positioned as previously determined and may have an appearance as previously determined. As discussed above, the AR viewer 110 may show both the real world and one or more virtual objects to the user, where in this case the virtual objects are the flags. The user may therefore see the real world in addition to the various flags. The flags may appear as a mark-up over the real world.

At block 250, the AR system 100 may receive a selection of a flag representing a tutorial. The user may be able to select a flag associated with a tutorial, and the manner of making the selection may depend, at least in part, on the AR viewer 110. For instance, if the AR viewer 110 is a smartphone screen, specifically a touchscreen, then the flags may be visible on the screen, and the user may touch a flag to select it. For another example, if the AR viewer 110 is a pair of glasses, then the AR system 100 may be configured to detect a position of the user's finger in the field of view and may thus detect when the user reaches out and touches a position in three-dimensional space that corresponds with (e.g., aligns with) the position of a flag. This detection may be interpreted as selection of the flag.

At block 255, the AR system 100 may play, or execute, the tutorial associated with the selected flag.

At block 260, the AR system 100 may update the user profile 130 of the user to indicate that the tutorial associated with the selected flag has been played. Specifically, this may include an update of the list of tutorials the user has played, and may also include an update to one or more of the user's skill scores, such as the skill score of the class of the tutorial. This updating of the user profile 130 may impact tutorials presented to the user in the future, because the update may affect user relevance scores and filtering based on skills in the future, and the update may also impact tutorials presented to other users in the future, as the update may affect peer relevance scores of tutorials for others.

It will be understood that, as the user moves the AR viewer 110, such as by moving the user himself, the field of view may change. When this occurs, the tutorials deemed visible may change. This may, in turn, impact the user list, the peer list, and the candidate list. As a result, the final list of tutorials whose flags are presented to the user may change. The appearance of flags may also change, because a change in which flags are displayed may change the positions of the flags or other variables considered when determining flag size. Thus, as the field of view of the AR viewer 110 changes, the AR system 100 may continuously update the flags presented to the user.

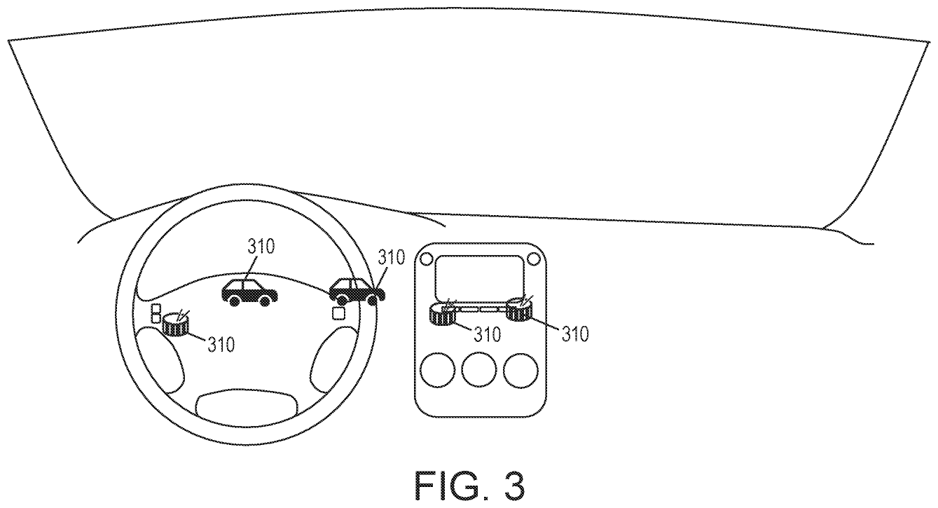

FIG. 3 is a display of an AR viewer 110 in an example use, according to some embodiments of the invention. Specifically, FIG. 3 shows a car interior as seen through the AR viewer 110, with several flags 310 indicating available tutorials that have been selected for a particular user based on the user profile 130 of the user. In this example, Rob has purchased a new car with many new features. The new car is the product. To learn about the vehicle's features, Rob puts on glasses that act as an AR viewer 110 while he sits in the driver's seat of the new car. The glasses communicate with Rob's smartphone, which acts as the computing device 120.

Rob enjoys music and plays drums in a band. In the new car, there are fifteen buttons related to playing music, and each button has an associated tutorial associated with a music class. The smartphone analyzes Rob's user profile 130 and recognizes indications of an affinity to music. For instance, the user profile 130 may indicate a high interest in music, such as through the frequency by which Rob listens to music as well as indications of band performances, which can be detected through a connection with Rob's social media. As such, these tutorials are assigned high user relevance scores based on the user profile 130. Users deemed peers of Rob regularly play four tutorials associated with driving, so these tutorials are assigned high peer relevance scores. All of these music tutorials and driving tutorials end up on the candidate list due to their high user relevance and peer relevance scores, respectively. Final scores and rankings are then calculated for each of these tutorials. Due to space considerations in the field of view, there is a predefined limit requiring the final list to have no more than five tutorials due to space considerations. It will be understood, however, that the use of five as a limit in this example is for illustrative purposes only. In this case, the top five final scores belong to three of the music tutorials and two of driving tutorials. Thus, these five tutorials are selected for inclusion in the final list.

Further, in this example, the AR system 100 determines that a steering wheel icon is appropriate for the driving tutorials, because this is the default icon for tutorials in the driving class. The AR system 100 also determines that album art illustrating a drum is appropriate for the music tutorials, because the album associated with this album art is Rob's current favorite according to Rob's user profile 130. Due to space considerations, a medium size is selected for the flags 310 representing the music tutorials, and a large size is selected for the flags 310 representing the driving tutorials. Each flag 310 of these ten tutorials in the final list may be displayed as the selected icon of the selected size. As Rob selects flags 310 and views tutorials, Rob's user profile 130 may be updated to reflect his interactions with the AR system 100, which may affect tutorials later presented to him as well as tutorials later presented to other users, such as peers. As such, Rob's interaction with the AR system 100 and use of tutorials is enhanced based on his personal user profile 130.

FIG. 4 is a block diagram of a computer system 400 for implementing some or all aspects of the system, according to some embodiments of this invention. The AR systems 100 and methods described herein may be implemented in hardware, software (e.g., firmware), or a combination thereof. In some embodiments, the methods described may be implemented, at least in part, in hardware and may be part of the microprocessor of a special or general-purpose computer system 400, such as a smartphone, tablet, personal computer, workstation, minicomputer, or mainframe computer. For example, and not by way of limitation, the computing device 120 in communication with the AR viewer 110 may be a computer system 400 as shown in FIG. 4.

In some embodiments, as shown in FIG. 4, the computer system 400 includes a processor 405, memory 410 coupled to a memory controller 415, and one or more input devices 445 and/or output devices 440, such as peripherals, that are communicatively coupled via a local I/O controller 435. These devices 440 and 445 may include, for example, a printer, a scanner, a microphone, and the like. Input devices such as a conventional keyboard 450 and mouse 455 may be coupled to the I/O controller 435. The I/O controller 435 may be, for example, one or more buses or other wired or wireless connections, as are known in the art. The I/O controller 435 may have additional elements, which are omitted for simplicity, such as controllers, buffers (caches), drivers, repeaters, and receivers, to enable communications.

The I/O devices 440, 445 may further include devices that communicate both inputs and outputs, for instance disk and tape storage, a network interface card (MC) or modulator/demodulator (for accessing other files, devices, systems, or a network), a radio frequency (RF) or other transceiver, a telephonic interface, a bridge, a router, and the like.

The processor 405 is a hardware device for executing hardware instructions or software, particularly those stored in memory 410. The processor 405 may be a custom made or commercially available processor, a central processing unit (CPU), an auxiliary processor among several processors associated with the computer system 400, a semiconductor-based microprocessor (in the form of a microchip or chip set), a macroprocessor, or other device for executing instructions. The processor 405 includes a cache 470, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 470 may be organized as a hierarchy of more cache levels (L1, L2, etc.).

The memory 410 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 410 may incorporate electronic, magnetic, optical, or other types of storage media. Note that the memory 410 may have a distributed architecture, where various components are situated remote from one another but may be accessed by the processor 405.

The instructions in memory 410 may include one or more separate programs, each of which comprises an ordered listing of executable instructions for implementing logical functions. In the example of FIG. 4, the instructions in the memory 410 include a suitable operating system (OS) 411. The operating system 411 essentially may control the execution of other computer programs and provides scheduling, input-output control, file and data management, memory management, and communication control and related services.

Additional data, including, for example, instructions for the processor 405 or other retrievable information, may be stored in storage 420, which may be a storage device such as a hard disk drive or solid-state drive. The stored instructions in memory 410 or in storage 420 may include those enabling the processor to execute one or more aspects of the AR systems 100 and methods of this disclosure.

The computer system 400 may further include a display controller 425 coupled to a display 430. In some embodiments, the computer system 400 may further include a network interface 460 for coupling to a network 465. The network 465 may be an IP-based network for communication between the computer system 400 and an external server, client and the like via a broadband connection. The network 465 transmits and receives data between the computer system 400 and external systems. In some embodiments, the network 465 may be a managed IP network administered by a service provider. The network 465 may be implemented in a wireless fashion, e.g., using wireless protocols and technologies, such as WiFi, WiMax, etc. The network 465 may also be a packet-switched network such as a local area network, wide area network, metropolitan area network, the Internet, or other similar type of network environment. The network 465 may be a fixed wireless network, a wireless local area network (LAN), a wireless wide area network (WAN) a personal area network (PAN), a virtual private network (VPN), intranet or other suitable network system and may include equipment for receiving and transmitting signals.

AR systems 100 and methods according to this disclosure may be embodied, in whole or in part, in computer program products or in computer systems 400, such as that illustrated in FIG. 4.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
determining a plurality of tutorials associated with a product visible through an augmented reality (AR) viewer in an AR system;
filtering the plurality of tutorials based on a user profile to generate a candidate set of tutorials; and
dynamically generating one or more flags representing one or more tutorials in the candidate set of tutorials.

2. The computer-implemented method of claim 1, wherein the filtering the plurality of tutorials based on the user profile comprises:
calculating a respective user relevance score for each tutorial in the plurality of tutorials, based on the user profile.

3. The computer-implemented method of claim 2, wherein the filtering the plurality of tutorials based on the user profile further comprises:
calculating a respective peer relevance score for each tutorial in the plurality of tutorials, based on one or more other user profiles deemed similar to the user profile.

4. The computer-implemented method of claim 3, wherein the calculating a respective peer relevance score for each tutorial in the plurality of tutorials, based on one or more other user profiles deemed similar to the user profile, comprises:
identifying a set of other users deemed to have similar skills to a user of the user profile; and
calculating the peer relevance score for each tutorial in the plurality of tutorials, based on the one or more user profiles of the set of other users deemed to have similar skills to the user.

5. The computer-implemented method of claim 3, wherein the filtering the plurality of tutorials based on the user profile further comprises:
including a first set of tutorials, selected from the plurality of tutorials, in a user list of tutorials based on the respective user relevance scores of the first set of tutorials;
including a second set of tutorials, selected from the plurality of tutorials, in a peer list of tutorials based on the respective peer relevance scores of the second set of tutorials;
calculating a respective final score for each tutorial in the first set of tutorials and for each tutorial in the second set of tutorials, wherein the final score of a tutorial is based on the respective user relevance score and the respective peer relevance score; and
selecting the candidate set of tutorials from the first set of tutorials and the second set of tutorials, based on the respective final scores of the first set of tutorials and the second set of tutorials.

6. The computer-implemented method of claim 1, further comprising:
filtering the candidate set of tutorials based on a space criterion to generate a final set of tutorials;
wherein the dynamically generating the one or more flags representing the one or more tutorials in the candidate set of tutorials comprises dynamically generating a flag representing each tutorial in the final set of tutorials.

7. The computer-implemented method of claim 6, wherein the dynamically generating the flag representing each tutorial in the final set of tutorials comprises determining a respective icon of the flag for each tutorial, wherein the respective icon of each flag is based on the user profile.

8. The computer-implemented method of claim 6, wherein the dynamically generating the flag representing each tutorial in the final set of tutorials comprises determining a respective size of the flag for each tutorial, wherein the respective size of each flag is based on the user profile.

9. A system comprising:
a memory having computer-readable instructions; and
one or more processors for executing the computer-readable instructions, the computer-readable instructions comprising:
determining a plurality of tutorials associated with a product visible through an augmented reality (AR) viewer in an AR system;
filtering the plurality of tutorials based on a user profile to generate a candidate set of tutorials; and
dynamically generating one or more flags representing one or more tutorials in the candidate set of tutorials.

10. The system of claim 9, wherein the filtering the plurality of tutorials based on the user profile comprises:
calculating a respective user relevance score for each tutorial in the plurality of tutorials, based on the user profile.

11. The system of claim 10, wherein the filtering the plurality of tutorials based on the user profile further comprises:
calculating a respective peer relevance score for each tutorial in the plurality of tutorials, based on one or more other user profiles deemed similar to the user profile.

12. The system of claim 11, wherein the filtering the plurality of tutorials based on the user profile further comprises:
including a first set of tutorials, selected from the plurality of tutorials, in a user list of tutorials based on the respective user relevance scores of the first set of tutorials;
including a second set of tutorials, selected from the plurality of tutorials, in a peer list of tutorials based on the respective peer relevance scores of the second set of tutorials;
calculating a respective final score for each tutorial in the first set of tutorials and for each tutorial in the second set of tutorials, wherein the final score of a tutorial is based on the respective user relevance score and the respective peer relevance score; and
selecting the candidate set of tutorials from the first set of tutorials and the second set of tutorials, based on the respective final scores of the first set of tutorials and the second set of tutorials.

13. The system of claim 9, the computer-readable instructions further comprising:
filtering the candidate set of tutorials based on a space criterion to generate a final set of tutorials;
wherein the dynamically generating the one or more flags representing the one or more tutorials in the candidate set of tutorials comprises dynamically generating a flag representing each tutorial in the final set of tutorials.

14. The system of claim 13, wherein the dynamically generating the flag representing each tutorial in the final set of tutorials comprises determining a respective icon of the flag for each tutorial, wherein the respective icon of each flag is based on the user profile.

15. A computer-program product for flagging tutorials in an augmented reality system, the computer-program product comprising a computer-readable storage medium having program instructions embodied therewith, the program instructions executable by a processor to cause the processor to perform a method comprising:
determining a plurality of tutorials associated with a product visible through an augmented reality (AR) viewer in an AR system;
filtering the plurality of tutorials based on a user profile to generate a candidate set of tutorials; and
dynamically generating one or more flags representing one or more tutorials in the candidate set of tutorials.

16. The computer-program product of claim 15, wherein the filtering the plurality of tutorials based on the user profile comprises:
calculating a respective user relevance score for each tutorial in the plurality of tutorials, based on the user profile.

17. The computer-program product of claim 16, wherein the filtering the plurality of tutorials based on the user profile further comprises:
calculating a respective peer relevance score for each tutorial in the plurality of tutorials, based on one or more other user profiles deemed similar to the user profile.

18. The computer-program product of claim 17, wherein the filtering the plurality of tutorials based on the user profile further comprises:
including a first set of tutorials, selected from the plurality of tutorials, in a user list of tutorials based on the respective user relevance scores of the first set of tutorials;
including a second set of tutorials, selected from the plurality of tutorials, in a peer list of tutorials based on the respective peer relevance scores of the second set of tutorials;
calculating a respective final score for each tutorial in the first set of tutorials and for each tutorial in the second set of tutorials, wherein the final score of a tutorial is based on the respective user relevance score and the respective peer relevance score; and
selecting the candidate set of tutorials from the first set of tutorials and the second set of tutorials, based on the respective final scores of the first set of tutorials and the second set of tutorials.

19. The computer-program product of claim 15, the method further comprising:
filtering the candidate set of tutorials based on a space criterion to generate a final set of tutorials;
wherein the dynamically generating the one or more flags representing the one or more tutorials in the candidate set of tutorials comprises dynamically generating a flag representing each tutorial in the final set of tutorials.

20. The computer-program product of claim 19, wherein the dynamically generating the flag representing each tutorial in the final set of tutorials comprises determining a respective icon of the flag for each tutorial, wherein the respective icon of each flag is based on the user profile.
